(19) United States
(12) Patent Application Publication
(10) Pub. No.: US 2017/0325092 A1
(43) Pub. Date: Nov. 9, 2017

(54) DISCOVERY MECHANISM FOR SERVICE SERVER CONNECTION

(71) Applicant: Nokia Technologies Oy, Espoo (FI)

(72) Inventors: Jarkko KNECKT, Espoo (FI); Mika KASSLIN, Espoo (FI); Janne MARIN, Espoo (FI); Enrico-Henrik RANTALA, Berkeley, CA (US); Olli ALANEN, Vantaa (FI)

(73) Assignee: Nokia Technologies Oy, Espoo (FI)

(21) Appl. No.: 15/531,417

(22) PCT Filed: Dec. 11, 2014
(86) PCT No.: PCT/US2014/069837

§ 371 Date: May 26, 2017

(51) Int. Cl. H04W 12/06; H04W 88/04

(52) U.S. Cl. CPC H04W 12/06; H04W 88/04

(57) ABSTRACT

In some example embodiments there is provided a method. The method may include sending, by a user equipment having a connection to a service at a cloud-based server, a publication message to a local cluster comprising at least one other user equipment and the user equipment, wherein the publication message offers to share, with the at least one other user equipment, the connection; receiving, by the user equipment, a request from the at least one other user equipment to access the connection made available by the user equipment, when the at least one other user equipment lacks connectivity to the service at the cloud-based server; and sending, by the user equipment, a response message indicating to the at least one other user equipment whether the at least one other user equipment is allowed to access the connection made available by the user equipment.

### FIELD

The subject matter described herein relates to wireless communications.

### BACKGROUND

Many applications today are provided as a service via for example a cloud/internet based connection. For example, cloud computing is an Internet technology that provides shared resources that are accessible when needed via the Internet. Cloud computing enables a user at a client computer to access services, such as computing resources including hardware resources (for example, computing capability, storage, etc.), software (for example, operating systems, end-user software applications, etc.), and a combination of both.

### SUMMARY

In some example embodiments, there is provided a method for discovering service specific connections.

In some example embodiments, there is provided a method, which may include sending, by a user equipment having a connection to a service at a cloud-based server, a publication message to a local cluster comprising at least one other user equipment and the user equipment, wherein the publication message offers to share, with the at least one other user equipment, the connection; receiving, by the user equipment, a request from the at least one other user equipment to access the connection made available by the user equipment, when the at least one other user equipment lacks connectivity to the service at the cloud-based server; and sending, by the user equipment, a response message indicating to the at least one other user equipment whether the at least one other user equipment is allowed to access the connection made available by the user equipment.

In some variations, one or more of the features disclosed herein including the following features can optionally be included in any feasible combination. The request may include authentication information to enable a determination of whether the at least one other user equipment is authorized to access the service. The user equipment and the at least one other user equipment may each include an application providing the service at the cloud-based server. The local cluster may include a neighbor awareness networking cluster coupled via one or more short range local links configured in accordance with at least one of WiFi, WiFi direct, Bluetooth, Bluetooth Low Energy, and/or or another radio technology. The connection may include a wireless link. At least one of the publication message, the request, or the response may be carried via one or more short range local links configured in accordance with at least one of WiFi, WiFi direct, Bluetooth, Bluetooth Low Energy, and/or or another radio technology. The request may be received in response to the publication message. When the response message indicates the at least one other user equipment is allowed to access the connection, the connection to the service may be shared with the at least one other user equipment.

In some example embodiments, there is also provided a method, which may include sending, by a user equipment lacking a connection to a service at a cloud-based server, a publication message to a local cluster comprising at least one other user equipment and the user equipment, wherein the publication message indicates a need for the connection; receiving, by the user equipment, a response from the at least one other user equipment indicating the availability of the connection at the at least one other user equipment; and sending, by the user equipment, authentication information to the at least one other user equipment, the authentication information authenticating the user equipment to at least the service or the at least one other user equipment.

In some variations, one or more of the features disclosed herein including the following features can optionally be included in any feasible combination. The user equipment and the at least one other user equipment may each include an application providing the service at the cloud-based server. The local cluster may include a neighbor awareness networking cluster coupled via one or more short range local links configured in accordance with at least one of WiFi, WiFi direct, Bluetooth, Bluetooth Low Energy, and/or or another radio technology. The connection may include a wireless link.

The above-noted aspects and features may be implemented in systems, apparatuses, methods, and/or computer-readable media depending on the desired configuration. The details of one or more variations of the subject matter described herein are set forth in the accompanying drawings and the description below. Features and advantages of the subject matter described herein will be apparent from the description and drawings, and from the claims. In some exemplary embodiments, one of more variations may be made as well as described in the detailed description below and/or as described in the following features.

### DESCRIPTION OF DRAWINGS

In the drawings,

FIG. 1 depicts an example of a system where service connection discovery may be implemented, in accordance with some example embodiments;

FIG. 2 depicts an example of a process for service discovery in a cluster, in accordance with some example embodiments;

FIG. 3 depicts another example of a process for service discovery in a cluster, in accordance with some example embodiments; and

FIG. 4 an example of an apparatus, in accordance with some example embodiments.

Like labels are used to refer to the same or similar items in the drawings.

### DETAILED DESCRIPTION

Cloud-based services, such as games, videos/movies, music, storage, or processing, and/or the like, may often need end-to-end server connectivity between the server providing the service and the user equipment accessing the cloud-based service in order to provide a full user experience. To illustrate by way of an example, a gaming application at for example a cloud-based server may provide as part of the service features, such as purchases (for example, providing virtual coins or other items), data backup (for example, tracking status and game points), and/or the like. In addition, the game service provider may push, via the server, new content (for example, a new level for the game) to the user equipment where the end-user is accessing the gaming application. If the user equipment does not have cloud connectivity (due to for example, cost of data roaming, lack of available WiFi hotspots or internet connection, and/or the like), the user equipment may not be able to obtain the full range of features provided by the service at the cloud-based server unless there is an available server connection.

In some example embodiments, there is provided a way to discover a server connection.

In some example embodiments, an application at a user equipment may provide a service, and this service may need a connection to a server, such as an internet, or cloud, based server. When the server connection is needed, the user equipment may obtain the server connection through another device in a cluster associated with the user equipment. For example, the user equipment lacking a server connection to the service may discover a neighboring user equipment having the server connection to the service and form a data path to that other user equipment, so that both user equipment can share the connection to the service at the server. In some example embodiments, the discovery of the other user equipment is performed via Neighbor Awareness Networking (NAN) discovery. When this is the case, the user equipment lacking the server connection performs NAN discovery and establishes a local link (for example, a NAN data path) via for example WiFi and/or any other short-range radio access technology (for example, Bluetooth, Bluetooth Low Energy, and/or the like).

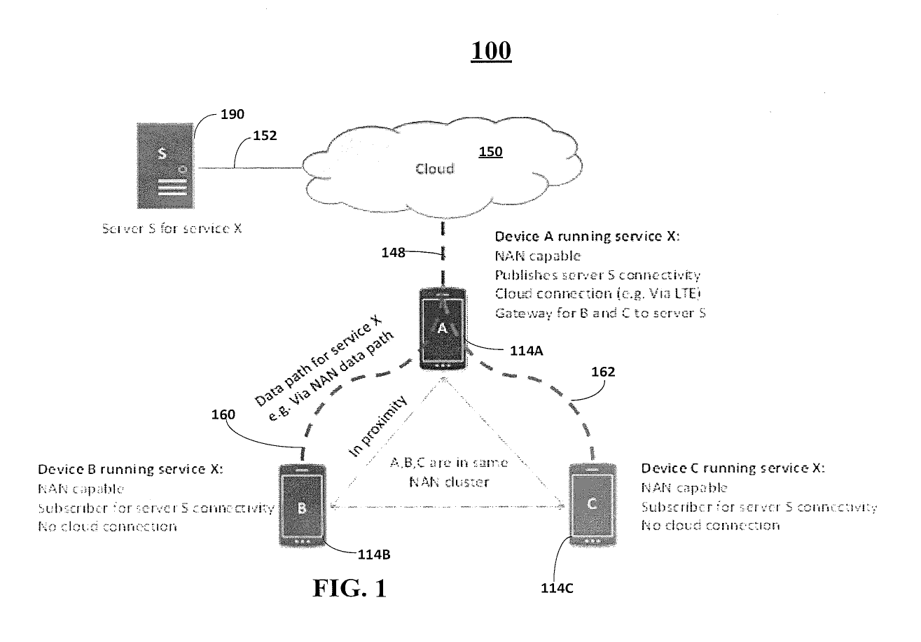

FIG. 1 depicts a system 100 including a plurality of user equipment 114A-C, in accordance with some example embodiments.

In the example of FIG. 1, user equipment 114A has a direct connection via cloud 150 to a server 190 hosting service X, but user equipment 114B-C do not have a direct server 190 connection. The direct connection 148 to cloud 150 may be via a WiFi wireless access point, cellular (for example, via a cellular base station), a wired Ethernet cable, or a combination thereof.

When connected to service X at server 190, user equipment 114A-C may provide a better user experience with respect to service X, providing as noted above a broader range of features. Accordingly, not having a connection to server 190 service X (via for example, the cloud/internet 150) may provide a lesser experience, when compared to having the server connection.

In the example of FIG. 1, user equipment 114A-C are neighboring devices and form a cluster, such as a NAN cluster, of devices some (if not all) of which may be running a same or similar application of service X. The NAN cluster may include, in some example embodiments, a plurality of user equipment 114A-C that are within for example short-range communication range (for example, WiFi range and/or the like), and can share a server connection for a given service provided by at least one of the devices in the cluster. For example, user equipment 114A may share its service X connection 148 to server 190 with user equipment 114B and/or 114C, which can tether via short-range paths 160 or 162 to user equipment 114A.

In some example embodiments, user equipment 114A (which has a direct server connection 148) has made discoverable the connection 148 to server 190 including service X. To that end, user equipment 114A may publish to the cluster the availability of server 190 where service X is located, and user equipment 114B-C may subscribe to published messages advertising connectivity to server 190 including service X. As such, when user equipment 114B and/or 114C discover that user equipment 114A has a connection (and can thus operate as a gateway to service X at server 190), user equipment 114B-C may each establish for example a short-range link 160 or 162 (via for example, WiFi, WiFi direct, Bluetooth, Bluetooth Low Energy, and/or the like) to user equipment 114A in order to access the connection 148 (as well as cloud 150 and backhaul link 152) to service X at server 190.

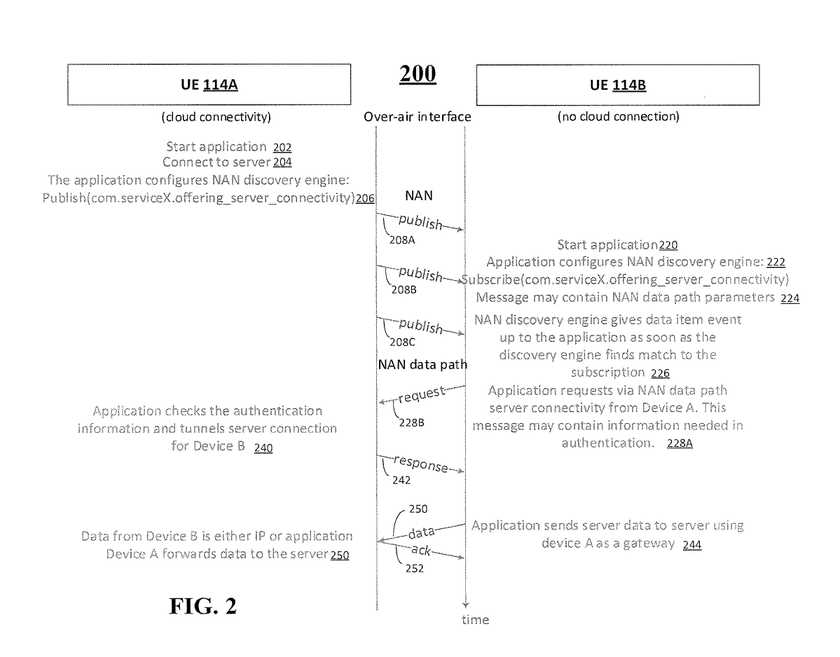

FIG. 2 depicts an example of a signaling diagram 200 between user equipment 114A (which has a cloud/server connection 148-152 to server 190 where service X is located) and user equipment 114B (which at a given instant in time does not have a direct cloud/server connection to server 190). The description of signaling diagram 200 also refers to FIG. 1.

At 202, an application may be started at user equipment 114A, in accordance with some example embodiments. For example, the application may provide a service X, such as a game, processing, storage, and/or the like, and this service X may also have some features hosted at server 190, which can be access via the internet/cloud 150. When the application for service X is started, user equipment 114A may establish, at 204, the connection 148-152 to server 190 where some of the features of service X may be accessed.

When the server connection is established, user equipment 114A may, at 206, publish the availability of the server connection established at 204, in accordance with some example embodiments. For example, user equipment 114A may determine that it is willing to share the connection 148 to service X at server 190 with other devices, such as other devices within the NAN cluster. Moreover, when user equipment 114A starts to publish the availability of the server connection, this may be an implicit indication that user equipment 114A is willing to share its connection. In some example embodiments, user equipment 114A may share it server connection in exchange for something else (for example, virtual credits and/or the like) from another user equipment or service X at server 190.

At 208A-C, user equipment 114A may send one or more messages publishing that user equipment 114A has a server connection to service X and/or server 190, in accordance with some example embodiments. In the example of FIG. 2, the publication message may include an indication of the service X service connection being offered and/or the _NAN data path configuration (for example, “publish (com.serviceX.offering_server_connectivity, NAN data path configuration parameters)”. Moreover, the publication message(s) may be sent at 208A-C via point-to-point signaling, a broadcast, and/or the like. In some example embodiments, the message(s) may be sent to one or more user equipment 114B-C in the vicinity of (or cluster associated with) user equipment 114A. Moreover, the user equipment 114A-C may form a cluster of wireless devices within short-range RF communication range of each other. This cluster may represent, in some example embodiments, a NAN cluster.

At 220, user equipment 114B may run an application providing service X, which may also trigger local discovery of server 190 connection to service X. At 224, user equipment 114B may subscribe to messages that indicate server 190 connection to service X. As such, when user equipment 114B receives a publication message 208B indicating that user equipment 114A has a server 190 connection to service X (for example, publish (com.serviceX.offering_server_connectivity), the NAN discovery engine may, at 226, provide to the application at user equipment 114B the connection configuration parameters for server 190 connection to service X which is available at user equipment 114A.

At 228A-B, user equipment 114B including the application/service X may request via NAN data path 160 access to server connection 148-152 to service X, in accordance with some example embodiments. The request sent at 228A-B may include authentication information to enable the user equipment 114A and/or the service X at 190 to authenticate user equipment 114B. For example, the request may include information (for example, a login identifier and/or password) to enable service X at user equipment 114A and/or server 190 to authenticate whether user equipment 114B should be granted access to service X.

At 240, user equipment 114A may determine whether to grant the request, in accordance with some example embodiments. For example, user equipment 114A may check whether user equipment 114B is authorized to access user equipment 114A (for example as part of the NAN cluster). Alternatively or additionally, user equipment 114A may check whether user equipment 114B is authorized to access service X at server 190. If authorized, user equipment 114A may respond at 242 with an indication of authentication. When this is the case, user equipment 114B may communicate (for example, send or receive) at 244 data with service X at server 190 via local data connection 160 to user equipment 114A, which acts as a gateway sharing at 250 the service connection to service X at server 190. Moreover, the connection counterpart of user equipment 114B may be either the server or the application of user equipment 114A. In the latter case, the application of user equipment 114A forwards the packets of 114B to the server. While in the former, user equipment 114B directly talks with the server and user equipment 114A just tunnels the packets through. In some example embodiments, user equipment 114B may receive an acknowledgement at 252 that the data was for example successfully received by the service X at the cloud server 190.

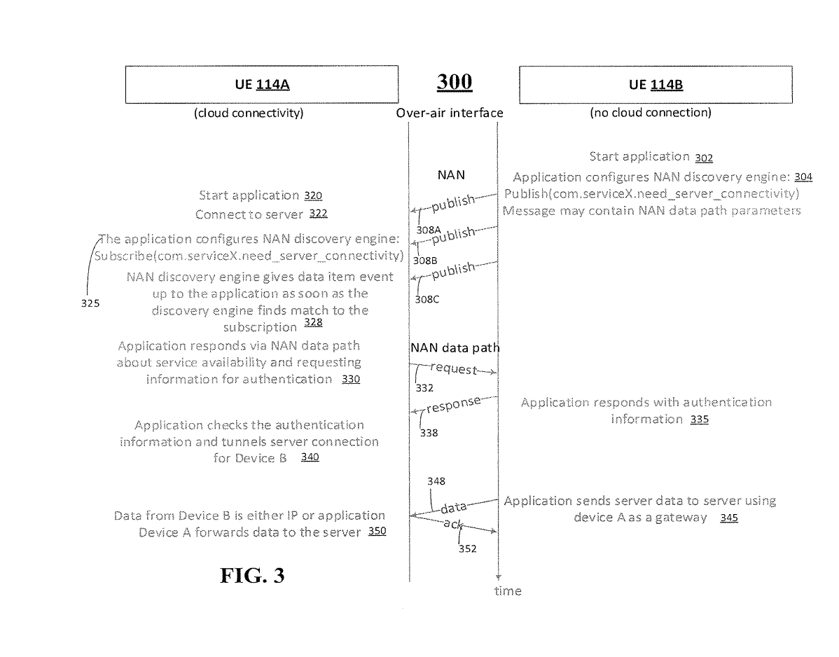

FIG. 3 depicts another example of a signaling diagram 300 between user equipment 114A (which has a cloud/server connection to server 190 where service X is located) and user equipment 114B (which at any given instant in time does not have a direct cloud/server connection to server 190). The description of signaling diagram 300 also refers to FIG. 1. Signaling diagram 300 is similar to signaling diagram 200, but signaling diagram 300 depicts user equipment 114B as the publisher.

At 302, an application for service X may be started at user equipment 114B, in accordance with some example embodiments. Moreover, user equipment 114B may not have a connection to service X at server 190. When that is the case, user equipment 114B may discover whether another device within the cluster has a server connection to service X at server 190. To that end, when the application for service X is started, user equipment 114B may, at 304, publish one or more messages indicating a need for a server connection to service X at server 190 (for example, “publish(com.serviceX.need_server_connectivity)” or “publish (com.serviceX.need_server_connectivity, NAN data path configuration parameters)”). The publication message may also define how and/or when the NAN data path connection to user equipment 114B will be established (for example, e.g. which Wi-Fi channel, which type of messages will be used such as broadcast, unicast or multicast, and/or the like, times for wake up, and/or the like).

The publication message(s) may be sent at 308A-C via point-to-point signaling, a broadcast, and/or the like. Moreover, the publication message(s) may be sent at 308A-C via NAN data paths, such as via WiFi direct, WiFi, Bluetooth, Bluetooth Low Energy, and/or the like between devices in the cluster. In some example embodiments, the message(s) may be sent to one or more user equipment 114A or C in the vicinity of user equipment 114B, such as the other user equipment in the same cluster or NAN cluster.

At 320, user equipment 114A may run an application providing service X, which may trigger, at 322, a connection establishment 148-152 to service X at server 190 and try to discover devices that need a server connection to service X, in accordance with some example embodiments. When user equipment 114A receives a publication message 308B indicating that user equipment 114B has a need for a server 190 connection to service X (for example, publish (com.serviceX.need_server_connectivity), the NAN discovery engine may, at 328, provide to the application at user equipment 114A the parameters indicating the identity of user equipment 114B (which needs the server connection) and/or an identifier of the NAN data path 160.

At 330-332, user equipment 114A including the service X application may respond via local link 160 (for example, a NAN data path if known or via a broadcast or multicast) to user equipment 114B, and this response may indicate that a service X connection to server 190 is available for use at user equipment 114A. At 335 and 338, user equipment 114B may respond, and this response may include authentication information to enable the user equipment 114A and/or the service X at 190 to authenticate user equipment 114B (for example, a login identifier and/or password).

At 340, user equipment 114A may check whether user equipment 114B is authorized and/or authenticated to access service X, and if so, user equipment 114A serves as a gateway by sharing with user equipment 114B its connection to service X at server 190. In some example embodiments, user equipment 114A may provide an indication of whether the authentication succeeded, although in some example embodiments this indication may not be implemented.

At 345 and 348, user equipment 114B may communicate (for example, send or receive) data with service X at server 190 via local data connection 160 to user equipment 114A, which acts as a gateway sharing at 350 the service connection to service X at server 190, in accordance with some example embodiments. In some example embodiments, user equipment 114B may receive an acknowledgement at 352 that the data was for example successfully received by the service X at the cloud server 190.

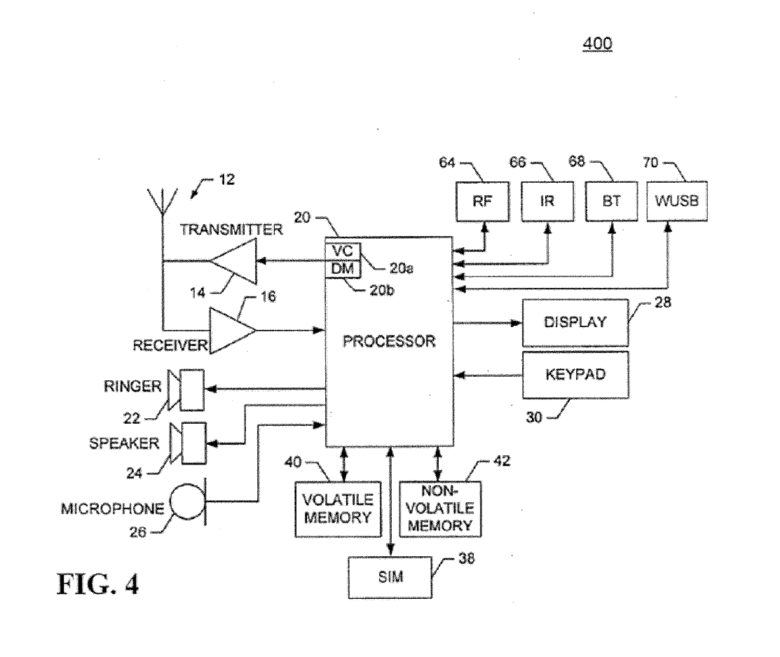

FIG. 4 depicts an example of an apparatus 400, in accordance with some example embodiments. The apparatus 400 may be implemented as a smart phone, a cell phone, an Internet of Things sensor/actuator, a wearable radio device, a camera, a video camera, a gaming console, and/or any other radio-based device Moreover, apparatus may establish local links to neighboring nodes, such as other user equipment, and/or form a NAN cluster in order to share a connection to a service at a gateway.

In some example embodiments, apparatus 400 may also include a radio communication link to a cellular network, and/or other wireless network. The apparatus 400 may include at least one antenna 12 in communication with a transmitter 14 and a receiver 16. Alternatively transmit and receive antennas may be separate.

The apparatus 400 may also include a processor 20 configured to provide signals to and from the transmitter and receiver, respectively, and to control the functioning of the apparatus. Processor 20 may be configured to control the functioning of the transmitter and receiver by effecting control signaling via electrical leads to the transmitter and receiver. Likewise, processor 20 may be configured to control other elements of apparatus 130 by effecting control signaling via electrical leads connecting processor 20 to the other elements, such as a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Apparatus 400 may include a location processor and/or an interface to obtain location information, such as positioning and/or navigation information. Accordingly, although illustrated in as a single processor, in some example embodiments the processor 20 may comprise a plurality of processors or processing cores.

Signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques, such as, Institute of Electrical and Electronics Engineers (IEEE) 802.11, 802.16, and/or the like. In addition, these signals may include speech data, user generated data, user requested data, and/or the like.

The apparatus 400 may be capable of operating with one or more air interface standards, communication protocols, modulation types, access types, and/or the like. For example, the apparatus 400 and/or a cellular modem therein may be capable of operating in accordance with various first generation (2G) communication protocols, second generation (2G or 2.5G) communication protocols, third-generation (3G) communication protocols, fourth-generation (4G) communication protocols, Internet Protocol Multimedia Subsystem (IMS) communication protocols (for example, session initiation protocol (SIP) and/or the like. For example, the apparatus 400 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the apparatus 400 may be capable of operating in accordance with 2.5G wireless communication protocols General Packet Radio Service (GPRS), Enhanced Data GSM Environment (EDGE), and/or the like. Further, for example, the apparatus 400 may be capable of operating in accordance with 3G wireless communication protocols, such as, Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 130 may be additionally capable of operating in accordance with 3.9G wireless communication protocols, such as, Long Term Evolution (LTE), Evolved Universal Terrestrial Radio Access Network (E-UTRAN), and/or the like. Additionally, for example, the apparatus 400 may be capable of operating in accordance with 4G wireless communication protocols, such as LTE Advanced and/or the like as well as similar wireless communication protocols that may be subsequently developed.

It is understood that the processor 20 may include circuitry for implementing audio/video and logic functions of apparatus 400. For example, the processor 20 may comprise a digital signal processor device, a microprocessor device, an analog-to-digital converter, a digital-to-analog converter, and/or the like. Control and signal processing functions of the apparatus 400 may be allocated between these devices according to their respective capabilities. The processor 20 may additionally comprise an internal voice coder (VC) 20a, an internal data modem (DM) 20b, and/or the like. Further, the processor 20 may include functionality to operate one or more software programs, which may be stored in memory. In general, processor 20 and stored software instructions may be configured to cause apparatus 400 to perform actions. For example, processor 20 may be capable of operating a connectivity program, such as, a web browser. The connectivity program may allow the apparatus 400 to transmit and receive web content, such as location-based content, according to a protocol, such as, wireless application protocol, wireless access point, hypertext transfer protocol, HTTP, and/or the like.

Apparatus 400 may also comprise a user interface including, for example, an earphone or speaker 24, a ringer 22, a microphone 26, a display 28, a user input interface, and/or the like, which may be operationally coupled to the processor 20. The display 28 may, as noted above, include a touch sensitive display, where a user may touch and/or gesture to make selections, enter values, and/or the like. The processor 20 may also include user interface circuitry configured to control at least some functions of one or more elements of the user interface, such as, the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 400 may include a battery for powering various circuits related to the mobile terminal, for example, a circuit to provide mechanical vibration as a detectable output. The user input interface may comprise devices allowing the apparatus 400 to receive data, such as, a keypad 30 (which can be a virtual keyboard presented on display 28 or an externally coupled keyboard) and/or other input devices.

Moreover, the apparatus 400 may include a short-range radio frequency (RF) transceiver and/or interrogator 64, so data may be shared with and/or obtained from electronic devices in accordance with RF techniques. The apparatus 400 may include other short-range transceivers, such as an infrared (IR) transceiver 66, a Bluetooth (BT) transceiver 68 operating using Bluetooth wireless technology, a wireless universal serial bus (USB) transceiver 70, and/or the like. The Bluetooth transceiver 68 may be capable of operating according to low power or ultra-low power Bluetooth technology, for example, Wibree, radio standards. In this regard, the apparatus 400 and, in particular, the short-range transceiver may be capable of transmitting data to and/or receiving data from electronic devices within a proximity of the apparatus, such as within 10 meters. The apparatus 400 including the Wi-Fi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

In some example embodiments, the NAN cluster is established via WiFi. When this is the case, communications between user equipment 114A-C may be performed over a NAN data path carried by a WiFi link between devices.

The apparatus 400 may comprise memory, such as, a subscriber identity module (SIM) 38, a removable user identity module (R-UIM), and/or the like, which may store information elements related to a mobile subscriber. In addition to the SIM, the apparatus 400 may include other removable and/or fixed memory. The apparatus 400 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing process 200, 300, and/or the like. The memories may comprise an identifier, such as an international mobile equipment identification (IMEI) code, capable of uniquely identifying apparatus 400. The functions may include one or more of the operations disclosed herein including sending, by a user equipment having a connection to a service at a cloud-based server, a publication message to a local cluster comprising at least one other user equipment and the user equipment, wherein the publication message offers to share, with the at least one other user equipment, the connection; receiving, by the user equipment, a request from the at least one other user equipment to access the connection made available by the user equipment, when the at least one other user equipment lacks connectivity to the service at the cloud-based server; and sending, by the user equipment, a response message indicating to the at least one other user equipment whether the at least one other user equipment is allowed to access the connection made available by the user equipment.

The memories may comprise an identifier, such as an international mobile equipment identification (IMEI) code, capable of uniquely identifying apparatus 400. In the example embodiment, the processor 20 may be configured using computer code stored at memory 40 and/or 42 to provide the operations, such as process 200, 300, and/or the like.

Some of the embodiments disclosed herein may be implemented in software, hardware, application logic, or a combination of software, hardware, and application logic. The software, application logic, and/or hardware may reside in memory 40, the control apparatus 20, or electronic components disclosed herein, for example. In some example embodiments, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as a computer or data processor circuitry. A computer-readable medium may comprise a non-transitory computer-readable storage medium that may be any media that can contain or store the instructions for use by or in connection with an instruction execution system, apparatus, or device, such as a computer. Furthermore, some of the embodiments disclosed herein include computer programs configured to cause methods as disclosed herein (see, for example, the process 200, 300, and the like).

Without in any way limiting the scope, interpretation, or application of the claims appearing below, a technical effect of one or more of the example embodiments disclosed herein is quicker discovery of available connections within a cluster (which may in some instances save power and/or processing).

The subject matter described herein may be embodied in systems, apparatus, methods, and/or articles depending on the desired configuration. For example, the systems, apparatus, methods, and/or articles described herein can be implemented using one or more of the following: electronic components such as transistors, inductors, capacitors, resistors, and the like, a processor executing program code, an application-specific integrated circuit (ASIC), a digital signal processor (DSP), an embedded processor, a field programmable gate array (FPGA), and/or combinations thereof. These various example embodiments may include implementations in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “machine-readable medium” refers to any computer program product, computer-readable medium, computer-readable storage medium, apparatus and/or device (for example, magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the example embodiments described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results. Other embodiments may be within the scope of the following claims.

1-30. (canceled)

31. A method comprising:
sending, by a user equipment having a connection to a service at a cloud-based server, a publication message to a local cluster comprising at least one other user equipment and the user equipment, wherein the publication message offers to share, with the at least one other user equipment, the connection;
receiving, by the user equipment, a request from the at least one other user equipment to access the connection made available by the user equipment, when the at least one other user equipment lacks connectivity to the service at the cloud-based server; and
sending, by the user equipment, a response message indicating to the at least one other user equipment whether the at least one other user equipment is allowed to access the connection made available by the user equipment.

32. The method of claim 31, wherein the request includes authentication information to enable a determination of whether the at least one other user equipment is authorized to access the service.

33. The method of claim 31, wherein the user equipment and the at least one other user equipment each include an application providing the service at the cloud-based server.

34. The method of claim 31, wherein the local cluster comprises a neighbor awareness networking cluster coupled via one or more short range local links configured in accordance with at least one of WiFi, WiFi direct, Bluetooth, Bluetooth Low Energy, or another radio technology.

35. The method of claim 31, wherein the connection comprises a wireless link

36. The method of claim 31, wherein at least one of the publication message, the request, or the response are carried via one or more short range local links configured in accordance with at least one of WiFi, WiFi direct, Bluetooth, Bluetooth Low Energy, or another radio technology.

37. The method of claim 31, wherein the request is received in response to the publication message.

38. The method of claim 31, wherein when the response message indicates the at least one other user equipment is allowed to access the connection, the method further comprises:
sharing the connection to the service with the at least one other user equipment.

39. An apparatus comprising:
at least one processor; and
at least one memory including computer program code, the at least one processor, the at least one memory, and the computer program code configured to cause the apparatus to at least:
send, by the apparatus having a connection to a service at a cloud-based server, a publication message to a local cluster comprising at least one other apparatus and the apparatus, wherein the publication message offers to share, with the at least one other apparatus, the connection;
receive, by the apparatus, a request from the at least one other apparatus to access the connection made available by the apparatus, when the at least one other apparatus lacks connectivity to the service at the cloud-based server; and
send, by the apparatus, a response message indicating to the at least one other apparatus whether the at least one other apparatus is allowed to access the connection made available by the apparatus.

40. The apparatus of claim 39, wherein the request includes authentication information to enable a determination of whether the at least one other apparatus is authorized to access the service.

41. The apparatus of claim 39, wherein the apparatus and the at least one other apparatus each include an application providing the service at the cloud-based server.

42. The apparatus of claim 39, wherein the local cluster comprises a neighbor awareness networking cluster coupled via one or more short range local links configured in accordance with at least one of WiFi, WiFi direct, Bluetooth, Bluetooth Low Energy, or another radio technology.

43. The apparatus of claim 39, wherein the connection comprises a wireless link

44. The apparatus of claim 39, wherein at least one of the publication message, the request, or the response are carried via one or more short range local links configured in accordance with at least one of WiFi, WiFi direct, Bluetooth, Bluetooth Low Energy, or another radio technology.

45. The apparatus of claim 39, wherein the request is received in response to the publication message.

46. The apparatus of claim 39, wherein when the response message indicates the at least one other apparatus is allowed to access the connection, the connection to the service is shared with the at least one other apparatus.

47. The apparatus of claim 39, wherein the apparatus comprises a user equipment, and the at least one other apparatus comprise at least one other user equipment.

48. An apparatus comprising:
at least one processor; and
at least one memory including computer program code, the at least one processor, the at least one memory, and the computer program code configured to cause the apparatus to at least:
sending, by the apparatus lacking a connection to a service at a cloud-based server, a publication message to a local cluster comprising at least one other apparatus and the apparatus, wherein the publication message indicates a need for the connection;
receiving, by the apparatus, a response from the at least one other apparatus indicating the availability of the connection at the at least one other apparatus; and
sending, by the apparatus, authentication information to the at least one other apparatus, wherein the authentication information authenticates the apparatus to at least the service or the at least one other apparatus.

49. The apparatus of claim 48, wherein the apparatus and the at least one other apparatus each include an application providing the service at the cloud-based server.

50. The apparatus of claim 48, wherein the local cluster comprises a neighbor awareness networking cluster coupled via one or more short range local links configured in accordance with at least one of WiFi, WiFi direct, Bluetooth, Bluetooth Low Energy, or another radio technology.
